(19) United States
(12) Patent Application Publication
(10) Pub. No.: US 2008/0315863 A1
(43) Pub. Date: Dec. 25, 2008

(54) Apparatus For the Measurement of a Streaming Potential of a Liquid Containing Solid Matter

(76) Inventor: Markus Mornhinweg, Diessen (DE)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 12/093,828

(22) PCT Filed: Nov. 14, 2006
(86) PCT No.: PCT/EP2006/010911

§ 371 Date: Aug. 12, 2008

(30) Foreign Application Priority Data
Nov. 17, 2005 (DE) 10 2005 054 934.9
Dec. 22, 2005 (DE) 10 2005 061 639.9

(51) Int. Cl. G01N 27/00

(52) U.S. Cl. 324/92

(57) ABSTRACT

Disclosed is an apparatus for measuring a streaming potential of a liquid containing solid matter. Said apparatus comprises a first electrode device relative to the direction of flow, said first electrode device being provided with a first rod-shaped electrode, as well as a second electrode device encompassing a second rod-shaped electrode, and a filter device located between the electrode devices. In order to improve the reproducibility and stability of the test results, the first electrode is embedded in a wall of a duct of the first electrode device so as to protrude into the duct by a maximum of half the diameter thereof perpendicular to the direction of flow.

The invention relates to an apparatus for the measurement of a streaming potential of a liquid containing solid matter according to claim 1.

In addition to the surface energy, the zeta potential plays a decisive role in interactions in boundary layers which occur, for example, in large numbers in solid matter suspensions. The zeta potential is a measure for ionic adsorption processes in the boundary layer and provides information regarding how strongly ions are bound. The zeta potential also serves as a characteristic for acid/base properties of fibre and powder surfaces. In this case the zeta potential may possibly be neutralised by an accumulation of ions at the interfaces in the transition area between the solid matter surface and the fluid and thus also serves as a measure for the stability of suspensions and emulsions.

In the industry, particularly during micro-encapsulation processes, the zeta potential of the primary constituents is used to optimise the process cycle in order to make the best possible choice of suitable additives for said micro-encapsulation process and thus to enable the achievement of an increase in the efficiency of said encapsulation process.

Measurement of the zeta potential also plays a decisive role particularly in paper manufacture. Here, amongst other things, synthetic sizing agents such as alkyl ketene dimer (AKD) and alkyl succinic anhydride (ASA) are used as hydrophobing agents. The sizing systems frequently have different zeta potentials and thus different properties such that the paper maker must weigh up which is the best sizing agent for his paper machine or particular paper product. In this regard, the zeta potential in particular of the fibres present in the pulp plays a decisive role. Particularly in recycled paper manufacture, the zeta potential of the fibres present in the pulp differs from batch to batch as the composition of the raw materials (waste paper) of the pulp varies constantly. Hence, particularly during recycled paper manufacture, the zeta potential of the pulp must be determined continuously so that appropriate sizing agents and additives can be added. In this regard the zeta potential plays a decisive role.

Normally, the zeta potential is determined according to the streaming potential method. To do this, the streaming potential and the conductivity of the suspension are measured first and it is from this that the zeta potential is subsequently determined. The streaming potential method is a physical surface analysis procedure for characterising the electrokinetic properties of solids in contact with aqueous solutions. If a solid is in contact with an aqueous electrolytic solution, then the distribution of the electrical charge present at the phase boundary is different from that inside the liquid phase. The enrichment of charge carriers at the phase boundary leads to the formation of an electrochemical double layer: the charge carriers located on the surface of a solid are compensated by counterions which are located partly in rigid arrangement and partly in diffuse distribution in the liquid. To determine the zeta potential according to the streaming potential method, a movement of the liquid is generated by a driving pressure in a measuring cell in which is located a capillary system. A pressure drop occurs in the measuring cell depending on the resistance to fluid flow in the streaming duct. The electrolyte flow brings about a charge displacement along the streaming duct in the direction of flow as only the mobile ions in the diffuse layer are entrained in the direction of flow but not, however, ions absorbed in the rigid layer as a result of Stokes friction. The resulting difference in potential is identified by measuring electrodes located at both ends of the streaming duct. The zeta potential is approximately identical to the potential of a boundary between rigid and diffuse layer and may be calculated from the streaming potential measured.

According to the prior art, various devices are known for determining the zeta potential in accordance with the streaming potential method. These devices are designed in respect of paper production to determine the electrokinetic properties in chemically “pure” pulps, i.e. in pulps where the starting products are fibres for high-quality and new paper. When using such clean raw materials, the pulp generated during paper manufacture is loaded with only a few chemical additives (printing ink, sizing agents, bleaching agents, etc.) such that due to a low chemical reaction or similar interaction in the pulp it is usually possible to apply the determination of zeta potential without any trouble, whereby the actual measuring signal, that is the streaming potential, differs significantly from the interference signal possibly present.

Printed matter U.S. Pat. No. 4,535,285 discloses a method for measurement of the streaming potential within a liquid containing fibrous material whereby a multiplicity of streaming processes of the liquid are generated through a filter cake and the streaming potential arising across the filter cake is stored as a series of potential measurements. The large number of streaming processes of the liquid are repeated with periodic frequency. The known method also has the process step of storing the streaming process as a series of streaming measurements. Also disclosed in the printed matter is an apparatus for measuring the streaming potential within a liquid containing fibrous material whereby a multiplicity of streaming processes of the liquid are generated through the filter cake and the streaming potential arising across the filter cake is stored as a series of potential measurements. For this are provided a pipe which is capable of being flowed through and which is closed off by a filter, a flow generating device to convey the suspension through the pipe and to generate the filter cake on the filter, and an electrode arrangement for measuring the electrical potential over at least parts of the filter cake. In addition, the conventional apparatus has a flow measuring arrangement to detect and store a series of streaming measurements, a computing device to derive the level of the streaming potential and a streaming device to control the streaming process.

Printed matter “Zeta Potential Experiences with Laboratory and Online Measurements” by ROHLOFF E.; HÖSCHLE O. discloses a procedure for measuring the streaming potential within a liquid containing fibrous material and an apparatus for measuring a streaming potential with a liquid containing fibrous material. The known apparatus has a pipe which is capable of being flowed through and which is closed off by a filter; a flow generating device to convey the suspension through the pipe and to generate the filter cake on the filter; and an electrode arrangement for measuring the electrical potential existing over at least parts of the filter cake. Furthermore, the printed matter discloses a flow measuring arrangement for identifying and storing a series of streaming measurements; a computer device; and a control device for controlling the streaming process.

An apparatus of the type referred to at the outset is known from DE 102 00 654 A1. It is considered problematic with this device that the reproducibility of the measurements frequently leaves a lot to be desired.

The object of the invention is to develop an apparatus of the type referred to at the outset to the effect that the reproducibility of the measured results is improved. This object is achieved by an apparatus according to claim 1.

In particular, this object is achieved with an apparatus for measuring a streaming potential of a liquid containing solid matter, said apparatus comprising a first electrode device relative to the direction of flow, said first electrode device being provided with a first rod-shaped electrode, as well as a second electrode device encompassing a second rod-shaped electrode, and a filter device located between said electrode devices. The first electrode is preferably embedded in a wall of a duct of the first electrode device so as to protrude into the duct by a maximum of the diameter thereof, preferably by a maximum of half the diameter thereof, perpendicular to the direction of flow.

Surprisingly it has been shown that by this arrangement and design of the two electrodes, that is to say also of the electrode that is located in the liquid which contains the solid matter, a considerable increase is achieved in the reproducibility of the measured results. Cleaning of the arrangement is also made considerably easier.

Preferably at least the first electrode has a round cross-section. Such a round cross-section is particularly easy to manufacture.

At least the first electrode is preferably fabricated from a drawn wire. When drawing wires it is possible in a simple manner to produce an even and above all very smooth surface.

In order to achieve good reproducibility of the measured results using both a single measuring instrument with replaceable electrode devices and also using a multiplicity of measuring instruments with such electrode base devices, preferably the first but also the second electrodes are fabricated from a single batch of drawn wire. As a result it is possible to achieve a significant and previously impossible increase in the reproducibility of the measured results of a plurality of instruments or instruments with a plurality of measuring cells or replaceable electrode devices.

Preferably the first and/or second electrode is fabricated from platiniridium or is drawn from a wire made from this material. This material provides surprisingly good results particularly with regard to the constancy of the measured results or the reproducibility thereof.

The first and/or second electrode preferably has/have a defined surface roughness. It is possible when drawing to achieve a very smooth surface. It is also possible, however, to achieve a defined roughness, e.g. by blasting and/or etching and/or electropolishing of the electrode surfaces. With this defined surface roughness, all the electrodes then in turn have very similar to identical properties within the measuring cells.

The filter device preferably comprises a replaceable strainer such that it is easy to clean. In addition, the filter device may also comprise a paper filter capable of being placed on the strainer which is particularly the case if the solids are very small particles.

Preferred embodiments emerge from the subclaims.

An embodiment of the invention is described in greater detail in the following on the basis of drawings. The drawings show

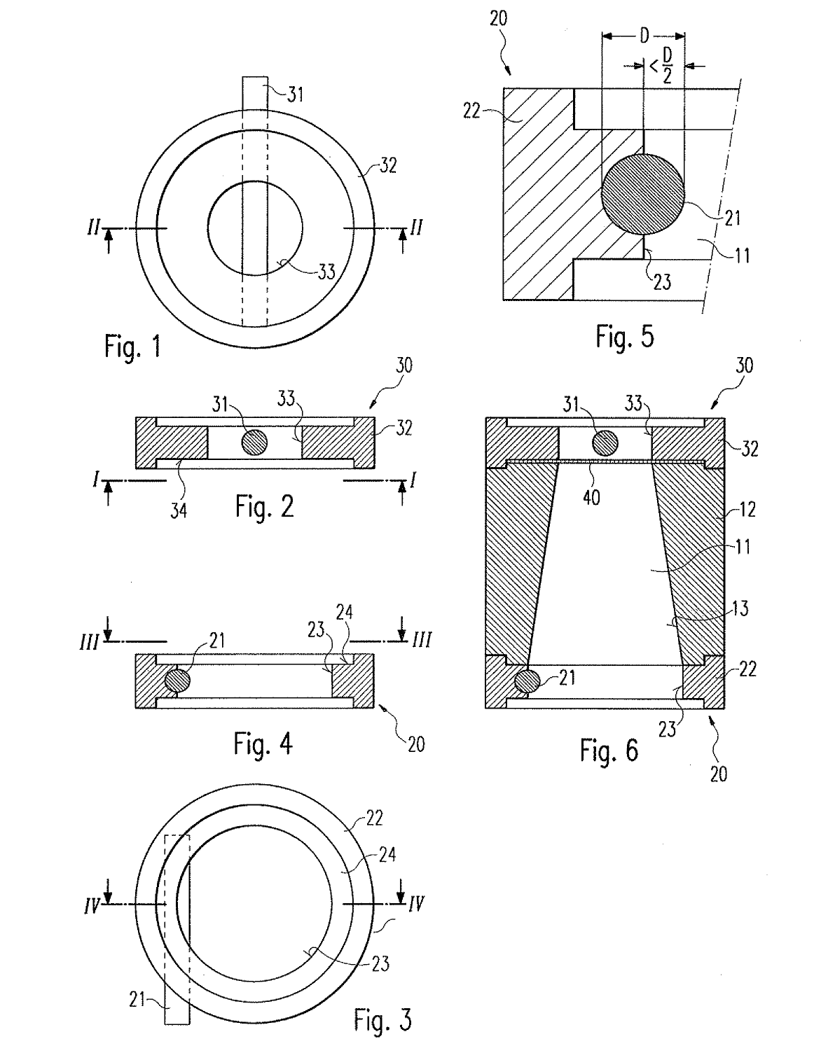

FIG. 1 a view from above onto a second electrode device,

FIG. 2 a section along line II-II through the arrangement according to FIG. 1,

FIG. 3 a view from above onto a first electrode device,

FIG. 4 a section along line IV-IV from FIG. 3,

FIG. 5 a detailed view of a section according to FIG. 4 and

FIG. 6 a longitudinal section through a measuring cell with the electrode devices.

The same reference numerals are used in the following description for identical parts and parts acting in an identical manner.

Measuring cell 10 shown in the Figures (see particularly FIG. 6) has a duct 11 which tapers towards the top according to the drawings.

The test liquid flows through duct 11 in this direction of taper. The test liquid initially flows through a first electrode device 20 having a holding frame 22 in which an electrode 21 is fixed, The test liquid subsequently flows through an adapter 12 and a second electrode device 30 having a holding frame 32 in which a second electrode 31 is fixed. Holding frame 22 of the first electrode device is joined liquid-tight but detachably to adapter 12 by way of a shoulder 24. Holding frame 32 of second electrode device 30 is joined liquid-tight but detachably to adapter 12 by way of a shoulder 34 whereby a filter device 40 is attached at the joining point, said filter device comprising for a start a replaceable strainer. A filter paper may also be placed on in addition.

Holding frames 22 and 32 of first electrode device 20 and second electrode device 30 respectively have concentric holes, the walls 23 and 33 of which respectively are aligned with a wall 13 of adapter 12 at the transition areas.

First electrode 21 is, as may be seen particularly from FIGS. 3 and 4, embedded tangentially to wall 23 of first electrode device 20 or its holding frame 22 such that its outer surface, as shown in FIG. 5, protrudes over wall 23 or into duct 11 with half (or less) of its diameter D. In order to achieve this, a hole for first electrode 21 is initially introduced into holding frame 32 before the central hole for forming wall 23 of holding frame 22 is introduced. This means that precise fabrication is possible in a simple manner.

Second electrode 31 of second electrode device 30 is fixed centrally in holding frame 32 as shown by FIGS. 1 and 2.

The special attachment of first electrode 21 now ensures that after use and also during use solids which are located in the test liquid cannot find any place, particularly no undercut, in which they might accumulate.

Second electrode 31 is located downstream of the filter in the direction of flow such that solids do not touch it.

This special arrangement of first electrode 21 has brought about astonishing advantages compared to a central arrangement as with second electrode 31. The measured values in particular are considerably more stable and reproducible than previously.

Platiniridium is used particularly as the material for electrodes 21 and 31 whereby drawn wire particularly is used as the semi-finished product. The drawing process produces an extremely even surface such that when manufacturing a plurality of (replaceable) electrode devices 20/30 the measured data achievable lie within a very narrow tolerance range. With this material there is also no danger that the surface will be damaged or altered during cleaning as the material is very hard.

It should be pointed out expressly at this point that the shape of the electrodes may also deviate from a circular cross-section if the criterion of tangential protrusion into the duct as referred to above is guaranteed. Furthermore, a plurality of first electrodes 21 may also be inserted into holding frame 22 if this is desirable for technical measurement reasons.

### LIST OF REFERENCE NUMBERS

10 Measuring cell
11 Duct
12 Adapter
13 Wall
20 First electrode device
21 First electrode
22 First holding frame
23 First wall
24 Shoulder
30 Second electrode device
31 Second electrode
32 Second holding frame
33 Second wall
34 Shoulder
40 Filter device
D Electrode diameter

What is claimed is:

1. Apparatus for measuring a streaming potential of a liquid containing solid matter, said apparatus comprising a first electrode device relative to the direction of flow, said first electrode device being provided with a first rod-shaped electrode, as well as a second electrode device encompassing a second rod-shaped electrode, and a filter device located between the electrode devices.

2. Device according to claim 1, characterised in that the first electrode is embedded in a wall of a duct of the first electrode device so as to protrude into the duct by a maximum of the diameter (D) thereof, preferably by a maximum of half the diameter (D) thereof substantially perpendicular to the direction of flow.

3. Device according to claim 1, characterised in that at least the first electrode has a circular cross-section.

4. Device according to claim 1, characterised in that at least the first electrode is fabricated from a drawn wire.

5. Device according to claim 1, characterised in that a plurality of first and/or second electrode devices are provided, the first or second electrodes of which respectively are all fabricated from a single batch of drawn wire.

6. Device according to claim 1, characterised in that the first and/or second electrode consist of platiniridium.

7. Device according to claim 1, characterised in that the first and/or the second electrode has a defined surface roughness, especially due to blasting and/or etching and/or electropolishing.

8. Device according to claim 1, characterised in that the filter device comprises a preferably removable strainer.

9. Device according to claim 8, characterised in that the filter device comprises a paper filter applied to the strainer.

10. Device according to claim 1, characterised in that the second electrode is disposed so as to cross the duct substantially centrally.
